(19) United States
(12) Patent Application Publication
(10) Pub. No.: US 2007/0045297 A1
(43) Pub. Date: Mar. 1, 2007

(54) MICROWAVE-ASSISTED PROCESSES AND EQUIPMENT THERFOR

(76) Inventors: Jocelyn J.R. Pare, Nepean (CA); Jean Francois Rochas, Caluire (FR); Jacqueline M.R. Belanger, Nepean (CA)

Correspondence Address: IAN FINCHAM, SUITE 606, 225 METCALFE STREET, OTTAWA, ON, K2P 1P9, CA

(21) Appl. No.: 11/308,975

(22) Filed: Jun. 1, 2006

Related U.S. Application Data
(63) Continuation-in-part of application No. 11/160,602, filed on Jun. 30, 2005, now abandoned.

(30) Foreign Application Priority Data
Jul. 2, 2004 (CA) 2472896

(51) Int. Cl. H05B 6/64

(52) U.S. Cl. 219/679

(57) ABSTRACT

The present invention provides for a system for effecting microwave assisted processes, the improvement comprising the combination of a source for generating microwave radiation, for example with a solid state generator, a self-adjusting cavity for receiving microwave radiation and for receiving a sample to be treated with the microwave radiation; and a coaxial cable for transmitting microwave radiation from the source to a cavity containing the sample, the coaxial cable is directly associated with the cavity whereby a sample in the cavity is adapted to directly receive the microwave radiation from the coaxial cable.

### FIELD OF THE INVENTION

This invention relates to a microwave-assisted process and equipment, particularly those which can be used for automation. More specifically, the invention is directed microwave-assisted extraction, synthesis, and analysis of sample components, amongst other uses.

### BACKGROUND OF THE INVENTION

The use of microwave processes and technology for treatment of samples is known. By way of representative example, there are numerous patents granted in this field amongst which are U.S. Pat. Nos. (1991) 5,002,784; (1994) 5,338,557; (1995) 5,458,897; (1995) 5,377,426; (1996) 5,519,947; (1997) 5,675,909; (1998) 5,732,476; (1999) 5,884,417; and (2000) 6,061,926. Such applications include those aiming at the subsequent analysis of the treated materials.

The generation of volatiles from liquid or solid materials is enhanced and accelerated by microwave exposure. This phenomenon is based upon the fact that most gases interact with microwaves to a lesser extent than do liquid or solid materials. Hence, the microwave energy is imparted selectively to the sample because it possesses a larger dielectric constant than the surrounding gaseous medium.

By way of an example, where a sample consists of water as the matrix with benzene as the analyte of interest, and a gaseous headspace is present, such as air for the purposes of this example, microwaves can be applied to the sample and they freely reach the water matrix because the air interacts little with the microwaves. This leads to selective heating of the liquid phase rather than the gas phase in the container. The water molecules, present in much greater number than the analyte, interact with microwaves to a greater extent and are subject to increases in thermal energy. Some of this thermal energy can then be transferred to the benzene molecules that are in proximity and, in effect, contribute significantly to their enhanced volatilization.

This volatilized material reaches the headspace of the container and can be sampled and analyzed using conventional gas transfer lines and adequate analytical device such as a gas chromatograph. Other parameters are of importance, namely the heat capacity of the analyte with respect to that of water and the enthalpy of vaporization of the various materials. For example, if ‘X’ joules are applied it will need to be determined what effect on the “local” temperature of the different species and once the temperature reaches the effective boiling point of one substance under the prevailing environmental conditions it will need to be determined how much energy is imparted to the system before the temperature raises again.

In the former example, it would be highly desirable to be able to simplify the microwave treatment and subsequent analysis of samples compared to existing technologies. Typically, sampling equipment and methods are relatively complicated and have several limitations. For example conventional, non-microwave headspace technologies make use of passive resistive heating devices that are devoid of selective heating capacity and require that numerous heating devices be made available if analysis time is to be kept short because of the relatively long incubation time required to heat the sample effectively. Furthermore, changing treatment conditions is characterized by relatively long waiting periods due to the inherent thermal inertia associated with these devices (normally consisting of some form of oven/bath, transfer lines, and sample loops.

Microwave technologies are devoid of these limitations. However, even if one was to use current state-of-the art microwave technologies—by representative example, one may refer to U.S. Pat. No. 6,744,024 as showing typical current production equipment used for sample treatment and chemical reactions—one will be limited in the level of automation and integration into an overall analytical equipment. These limitations are due in part to the nature of the treatment cavities and also to the means for transmitting the microwave energy from a generator to the sampling cavities. Almost all known equipment to date utilizes microwave transfer means associated with a generator in the form of a microwave guide, which is normally a metallic device capable of transmitting the microwave energy to the microwave cavity containing the sample to be analyzed or subjected to a reaction. Hence, waveguides generally being made of non-flexible metal, microwave systems are generally of a fixed nature with little capacity to be fully integrated into other high-performance analytical devices such as gas chromatographs, liquid chromatographs, mass spectrometers, and the likes.

Furthermore, the design of such cavities is inherently flawed due to the very nature of the materials to be treated. Different chemicals (matrices) interact at different levels with microwaves. Hence, in order to enhance the efficiency of the system one must optimize the cavity—a process sometimes referred to as “tuning” the cavity. The rigidity and complexity of the design makes it difficult at best from a mechanical standpoint to remove the cavity and adjust the tuning. Moreover, the time and effort required for such cumbersome systems makes it impractical and, as a result, the equipment must be appended to some form of automatic tuning system. Accordingly, these systems are complicated, cumbersome, and costly.

Still further, due to the bulk and large weight of a conventional sample treatment apparatus, these systems are not readily transportable for use in the field. For example, it would be desirable to have a portable unit which could be carried by an individual to a site (possibly remote sites) and sampling carried out by the portable unit.

In light of the above, there is a need for a system which is relatively inexpensive and portable. Further, there is a need for a system that is readily adaptable for various tasks without requiring complicated and cumbersome optimization adjustments while providing equal, if not improved, testing sensitivity levels.

### SUMMARY OF THE INVENTION

The present invention provides for both novel equipment and techniques that have been developed and found particularly useful for the automation of gas-phase extraction (Headspace, HS) and analysis of volatile and semi-volatile organic compounds. Such automation is a significant advancement relative to today's modern analytical laboratory. With the ever increasing demand for processing samples and the lack of dedicated operators, there is a need for novel equipment which can be fully automated when performing gas-phase extraction of volatile and semi-volatile organic compounds.

In addition to automation, the present invention provides analytical tools that are simple, rapid and adaptable to various working environments—since sample preparation need not to be limited to the laboratory setting but can also be performed directly in the field. Accordingly, it is within the scope of this invention, in certain embodiments, to provide equipment and processes which relate to an automated and portable Microwave-Assisted Headspace equipment (MAP-HS).

It will be obvious to those skilled in the art that the use of such apparatus will not be reserved only the novel applications such as gas-phase extraction and volatiles generation and the description herein is not limitative nor exhaustive. In fact, the apparatus and methods described herein would apply equally well to processes involving liquid-phase extraction and chemical synthesis be it conventional reactions of high-energy density processes as described in U.S. Pat. No. 6,061,926.

In a preferred embodiment of this invention the user can select between a number of cavities that have been optimized for the application to be carried out. The simplicity of this task is not to be underestimated as only one connector is to be removed—by hand—in a matter of a few seconds and the attachment of a new cavity leads instantaneously to an optimized system without the need to further tune the system.

Obviously this is made further possible with the use of equipment relying on metal waveguides for microwave transmission. Thus, this invention will not only increase the number of applications available to field work but can also bring about improved sensitivity levels that are comparable to laboratory-based applications.

It will also be evident to those skilled in the art that by virtue of these innovations and characteristics, this invention will provide significant improvements over other systems such as, for example, small microwave cavities to be used to enhance chromatographic separations U.S. Pat. Nos. (e.g. (1999) 5,939,614; (2000) 6,029,498; (2000) 6,093,921 (2000) 6,157,015; (2001) 6,316,759; (2003) 6,514,316).

Still further, the ability to provide relatively inexpensive cavities that are tuned for selected materials or processes can enable the further enhancement of other energy—density driven processes (e.g. (2000) U.S. Pat. No. 6,061,926).

In accordance with the present invention, there is provided a system for effecting microwave assisted processes, the improvement comprising the combination of:

a source for generating microwave radiation;

a cavity for receiving microwave radiation and for receiving a sample to be treated with said microwave radiation; and,

a coaxial cable for transmitting microwave radiation from the source to a cavity containing the sample.

It is preferred that the coaxial cable is directly associated with the cavity whereby a sample in the cavity is adapted to directly receive the microwave radiation from the coaxial cable, the system further includes a cavity that is self-tuning or tunable.

By self-tuning or tunable cavity one refers to a cavity where the interaction of the microwaves is maintained at a maximum value precisely over or to the sample to be treated by the microwave-assisted process (as predicted by Maxwell's Equations).

The tuning function can be achieved via the insertion of a movable antenna that is displaced in order to ensure that the interaction between the microwaves and the sample is maximal. That antenna can be moved manually or can be controlled remotely through a computerized motor-driven mechanism in response to the measurement of the level of interaction the microwaves has with the material under treatment (self-tuning). It can also be varied in shape (length, configuration, etc.) to ensure the desired effect.

It will be evident to those skilled in the art that, alternatively and as described earlier herein, one could also manufacture a plurality of inexpensive, fixed tuning, cavities that have been previously tuned for selected materials to be treated. The advantages of this approach are simplicity and costs. They are made possible by the ease and efficiency with which this technology, using a coaxial connection, allows for the connection and disconnection of the cavity.

It will be further evident to those skilled in the art that this approach where the cavity is tuned for the sample to be treated is truly novel over existing technology where that cavity is of fixed configuration and where the energy the interaction of the microwaves with the sample is not maximized in function of the sample. Hence, the use of this technology leads to the need of generators of reduced capacity (as a result of the higher efficiency obtained through the use of tuned cavities or self-tunable cavities) that in turn leads to lower overall costs for the apparatus and the operation of the apparatus. In fact in some cases the use of the technology leads to the possibility of conducting some processes that cannot be effected when lower electrical field is applied as it is the case for current non-tuned cavities where the energy is deposited randomly in the cavity as opposed to directly in the sample to be treated by the microwave-assisted process.

Desirably, in the above system, the source of microwave radiation is a solid-state generator.

In a further preferred embodiment, the microwave generating means comprises a microwave capable of generating at least 100 W, and the coaxial cable is capable of transmitting microwave radiation generated by the source to the sample.

In yet a further preferred embodiment of the invention, the coaxial cable is a flexible coaxial cable.

It is further preferred that the system further comprises a portable means for generating the source of microwave radiation and a portable cavity for receiving the sample. Moreover, it is desirable in the above embodiment that an analytical determination device, the source, the cavity and the cable being adapted to be integrated with the analytical determination device, and the analytical determination device includes a generator and the cavity is remote from the generator for field deployment.

In another preferred embodiment, the cavity is removable and easily exchangeable with another whereby the cavities are manufactured so that each one is optimized, from a microwave application standpoint, to effect a selected application according to the nature of the matrix being subjected to treatment, thus removing the need to have cumbersome and complicated means to tune or optimize the cavities per current technologies.

In still another preferred embodiment, there is provided a system comprising a portable means for generating the source of microwave radiation and a portable cavity for receiving the sample.

In another aspect of the present invention, there is provided a method of treating a sample with microwave radiation comprising the steps of providing a sample to be treated, providing a source of microwave radiation, providing a cavity for receiving the sample, connecting the source of microwave radiation to the cavity via a coaxial cable, and generating microwave radiation with the source and transmitting the radiation via the coaxial cable to the sample.

In a further preferred embodiment, there is provided a method wherein the source of microwave radiation is generated by a solid-state generator.

In a still further preferred embodiment, there is provided a method wherein the microwave energy or radiation is transmitted to the sample from the source of microwave radiation via the coaxial cable, the coaxial cable being flexible, and the sample is adapted to be placed in a sealable container to prevent VOCs from leaking from the container.

A still further adaptation of the present invention relates to a method of analyzing a sample at a remote site, the improvement comprising the steps of providing a portable system, providing a sample from the remote site to be analyzed, and analyzing the sample using the system.

Desirably, the system operates at a fixed frequency of approximately 2450 MHz, the system further includes a source of microwave radiation generated by a solid state generator, the microwave radiation is transmitted to the sample from the source of microwave radiation via a coaxial cable, the coaxial cable being a flexible cable, the equipment operates at a fixed frequency of approximately 2450 MHz, and the sample is adapted to be placed in a sealable container to prevent VOCs from leaking from the container.

In addition, it is desirable, the system further includes microwave generating means comprising a microwave capable of generating at least 10 W and a coaxial cable capable of transmitting microwave radiation generated by the source.

### DETAILED DESCRIPTION OF THE INVENTION

The present invention provides for a combination of components comprising a system having means for generating microwave energy or radiation (10), a self tuning or tunable cavity (sample retention means) (20), coaxial cable means (30) operatively associated with the means for generating microwave energy and transmitting the energy through the coaxial cable means to the sample retention means. Preferably, the self-tuning or tunable cavity includes antenna means (40), which is capable of movement relative to a sample in the cavity so as to permit interaction between the microwave radiation and the sample to a maximum extent.

The present invention can utilize any conventional source for microwave generating microwave radiation—such equipment is well known in the art. In terms of the coaxial cable, the exact nature of the cable will vary depending on the amount of microwave energy to be transmitted from the microwave generator to the sample retention means, such as a sealable container. Most desirably, the coaxial cable comprises a length of cable that is generally flexible. Coaxial cables are known in different arts, e.g. the audio/video arts, but until the present invention, have not been employed for transmitting microwave energy or radiation according to the present invention.

Various modifications to the equipment can be made within the scope of the present invention. For example, in its most basic version the equipment can operate as a stand alone unit at a fixed frequency (2450 MHz) and power (e.g. 10-300 W) while the main variable is time.

Other embodiments of the present invention include variable power, self-adjusting cavities, various microwave sources (e.g., solid state), and full integration into analytical determination devices systems (e.g., GCs). In addition, the system may be configured so that the microwave cavity where the HS sample is placed is not co-located with the generator. Using this arrangement, the system permits maximum flexibility in the integration of the cavity within an overall analytical system or for implementation as a field-deployed instrument.

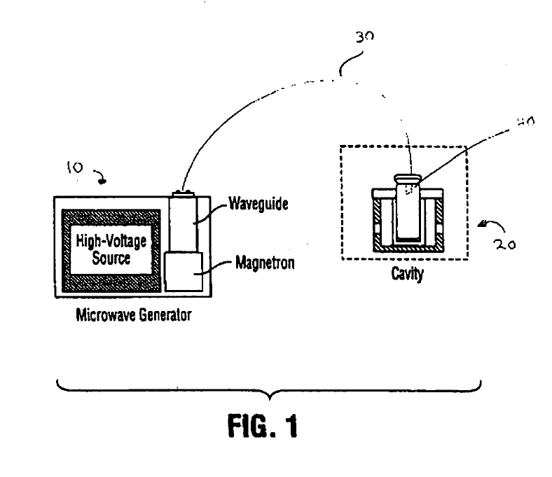

Referring now to FIG. 1, there is illustrated one embodiment of the present invention, shown in schematic form, utilizing a microwave generator/applicator system for automated MAP-HS equipment.

The following Examples illustrate the process of the present invention utilizing the above-described apparatus. For the Examples, the following procedure was used for sample preparation: A multi-component VOCs stock solution was made by diluting a Supelco Volatile Organic Compounds Mix 2 (13 components) quantitative calibration mixture in methanol. The original concentrations were of 200 μg/mL. The mixture was diluted with water to make for aqueous solutions varying between 4 and 0.008 ppm.

Thereafter, using conventional head space technology, Aliquots of 10-mL of these VOCs solutions were added to HS vials. The 20-mm pressure release safety aluminium cap with Teflon-faced black butyl rubber septum (HP part numbers 9301-0718 and 9301-0976 respectively) was crimped on tight to the point that no movement could be detected even if the cap was twisted hard.

The vials were then placed into a conventional static headspace sampler (a unit consisting of a modified HP7694 HS sampler; the unit is capable of performing conventional HS sampling procedures as per the commercially available HP7694E apparatus (as these features were not modified) where they were incubated for a period of time prior to sampling and GC analysis (HP6890).

Thereafter, a 10-mL aliquot of the same solution of VOCs in water was added to a commercial 20-mL HS vial. The vials were crimped air-tight until the cap could not rotate anymore. This was critical as the pressure build-up could be considerable after exposure to microwaves. The vial was placed in the various MAP-HS prototypes and irradiated at fixed power (75-300 W) for a fixed amount of time (30-75 s). Once the microwave exposure was complete, the sample was transferred into the same HS sampler to minimize errors due to pneumatics and GC—only the incubation time was set at “0”. The transfer time was kept constant to minimize errors due to heat exchange between the MAP cavity and the HS sampler.

Table 1 below summarizes typical operating parameters employed.

HS sampler Conditions (HP7694)

| | |
|---|---|
| Equilibration time | 30 min |
| Incubation temperature | 80° C. |
| Sample loop | 3 mL |
| Loop temperature | 90° C. |
| Transfer line temperature | 100° C. |

GC Conditions (HP6890)

| | |
|---|---|
| Column | HP-1, 30 m × 0.53 mm × 0.88 μm |
| | (He @ 5.3 mL/min) |
| Inlet | 150° C. (volatile, |
| | split operation with split 1:11) |
| Temperature program | 40° C. (1 min), to 160° C. |
| | (1 min) @ (Total analysis time 10 min) |
| Detector | FID @ 280° C. |

Microwave conditions

| | |
|---|---|
| Generator | Solid State, 100 W variable, 2450 MHz fixed |
| Exposure time | 75 s @ 100 W |

Table 2 demonstrates the results of conventional process in comparison with the process and apparatus of the present invention, for typical GC trace of VOCs in water.

[image]

Preliminary Data Obtained With Novel Solid-State Generator*

| | | MAP-HS/HS, (RSD, %) | | | | | |
|---|---|---|---|---|---|---|---|
| | HS 30 | 0.008 | 0.016 | 0.08 | 0.4 | 0.8 | 4 |
| Compound | min | ppm | ppm | ppm | ppm | ppm | ppm |
| Benzene | 1 | 2.0 | 2.1 | 1.9 | 1.9 | 1.9 | 1.9 |
| | | (0.0) | (4.1) | (0.6) | (1.7) | (2.3) | (1.2) |
| Toluene | 1 | 2.1 | 2.0 | 1.9 | 1.9 | 1.9 | 1.9 |
| | | (0.0) | (3.6) | (0.6) | (1.7) | (2.5) | (1.3) |
| Ethylbenzene | 1 | 1.9 | 2.0 | 1.8 | 1.8 | 1.8 | 1.8 |
| | | (0.0) | (3.8) | (1.5) | (1.7) | (2.5) | (1.4) |
| m-Xylene | 1 | 1.9 | 2.0 | 1.8 | 1.9 | 1.9 | 1.9 |
| | | (0.0) | (3.6) | (0.5) | (1.7) | (2.5) | (1.5) |
| Styrene | 1 | 2.3 | 2.4 | 2.2 | 2.2 | 2.2 | 2.2 |
| | | (1.2) | (3.4) | (0.8) | (1.4) | (2.5) | (1.5) |
| Bromobenzene | 1 | 2.4 | 2.6 | 2.2 | 2.4 | 2.3 | 2.4 |
| | | (4.5) | (3.2) | (1.1) | (1.0) | (2.4) | (1.6) |
| 1,3,5- | 1 | 1.9 | 1.9 | 1.8 | 1.9 | 1.9 | 1.8 |
| Trimethylbenzene | | (1.5) | (2.7) | (0.5) | (1.7) | (2.8) | (2.2) |
| 1,2,4- | 1 | 2.1 | 2.1 | 1.9 | 2.0 | 2.0 | 2.0 |
| Trimethylbenzene | | (1.4) | (3.1) | (0.6) | (1.7) | (2.7) | (2.4) |
| p- | 1 | 1.7 | 1.6 | 1.5 | 1.6 | 1.6 | 1.6 |
| Isopropyltoluene | | (1.9) | (2.6) | (0.4) | (1.8) | (2.5) | (2.5) |
| n-Buthylbenzene | 1 | 1.6 | 1.5 | 1.4 | 1.4 | 1.4 | 1.4 |
| | | (2.4) | (3.2) | (0.2) | (2.0) | (2.4) | (2.8) |
| 1,2,4- | 1 | 2.5 | 2.5 | 2.0 | 2.2 | 2.1 | 2.1 |
| Trichlorobenzene | | (10.0) | (3.8) | (1.1) | (1.2) | (2.0) | (4.4) |
| Naphthalene | 1 | 2.5 | 3.1 | 2.6 | 2.8 | 2.8 | 3.2 |
| | | (4.0) | (1.8) | (4.0) | (1.5) | (1.9) | (3.8) |
| 1,2,3- | 1 | 2.9 | 2.7 | 2.3 | 2.4 | 2.4 | 2.4 |
| Trichlorolbenzene | | (0.0) | (1.0) | (2.4) | (0.5) | (1.8) | (4.8) |

*Operated at 100 W for 75 s - no attempt was made to maximize the sensitivity

[image]

It will be evident to those skilled in the art that when these steps are effected with a unit that does not benefit from the tuned cavity described in this invention one is not able to obtain similar levels of sensitivity under similar power and time conditions. In fact, in some cases, even when power is increased significantly, the cavity is so much out-of-tune with respect to the sample to be treated that results exhibiting sensitivity enhancements such as those obtained by the use of this invention are impossible to reproduce.

What is claimed is:

1. In a system for effecting microwave assisted processes, the improvement comprising the combination of: a source for generating microwave radiation; a tunable cavity for receiving microwave radiation and for receiving a sample to be treated with said microwave radiation; the tunable cavity directing substantially all of the microwave radiation to the sample to obtain substantially maximum interaction of the microwave radiation with the sample, and a coaxial cable for transmitting microwave radiation from said source to a cavity containing said sample.

2. The system of claim 1, wherein said coaxial cable is directly associated with said cavity.

3. The system of claim 1, wherein said system further includes a cavity that is self-adjustable.

4. The system of claim 1, wherein said tunable cavity includes a movable antenna of fixed or variable length and shape capable of movement relative to a sample in said cavity to permit interaction between said microwave radiation and said sample to a maximum extent.

5. The system of claim 4, wherein said moveable antenna is manually moveable, and said coaxial cable is capable of transmitting microwave radiation generated by said source to the sample.

6. The system of claim 1, wherein said antenna is moveable using a remote control.

7. The system of claim 6, said system further comprising a portable means for generating said source of microwave radiation and a portable cavity for receiving said sample.

8. The system of claim 1, further including an analytical determination device, said source, said cavity and said cable being adapted to be integrated with said analytical determination device.

9. The system of claim 1, wherein said tunable cavity comprises at least one interchangeable pre-tuned cavity.

10. A method of treating a sample with microwave radiation comprising the steps of providing a sample to be treated, providing a source of microwave radiation, providing a tunable cavity for receiving said sample, placing the sample in the tunable cavity, connecting said source of microwave radiation to said cavity via a coaxial cable, and generating microwave radiation with said source and directing said microwave radiation to said sample whereby substantially all of the microwave radiation interacts with the sample.

11. The method of claim 10, wherein said tunable cavity includes a movable antenna of fixed or variable length and shape capable of movement relative to a sample in said cavity to permit interaction between said microwave radiation and said sample to a maximum extent.

12. A method as defined in claim 10, wherein said moveable antenna is manually moveable microwave generating means comprises a microwave generator, and said coaxial cable transmits microwave radiation generated by said source to the sample.

13. A method as defined in claim 12, wherein said sample is adapted to be placed in a sealable container to prevent VOCs from leaking from said container.

14. A method for automated analyzing of a sample at a remote site, the improvement comprising the steps of: providing a system according to claim 6, providing a sample at said remote site to be analyzed; and, analyzing said sample with said system.

15. A method as defined in claim 14, wherein said tunable cavity includes a movable antenna capable of movement relative to a sample in said cavity to permit interaction between said microwave radiation and said sample to a maximum extent.

16. The method of claim 14, wherein said moveable antenna is manually moveable microwave generating means comprises a microwave generator, and said coaxial cable transmits microwave radiation generated by said source to the sample.

17. A method as defined in claim 16, wherein said antenna is moveable using a remote control.

18. A method as defined in claim 17, wherein said tunable cavity comprises at least one interchangeable pre-tuned cavity.

19. A method as defined in claim 18, wherein said sample is adapted to be placed in a sealable container to prevent VOCs from leaking from said container.

20. The method of claim 17, wherein said system further includes microwave generating means comprising a microwave generator and a coaxial cable capable of transmitting microwave radiation generated by said source.
